(19) United States
(12) Patent Application Publication
(10) Pub. No.: US 2009/0039142 A1
(43) Pub. Date: Feb. 12, 2009

(54) Method for Forming a Solder Mold with Venting Channels and Method for Using the Same

(76) Inventors: Raschid Jose Bezama, Mahopac, NY (US); Russell Alan Budd, North Salem, NY (US); Evan George Colgan, Chestnut Ridge, NY (US); Peter Alfred Gruber, Mohegan Lake, NY (US); Valerie Oberson, Quebec (CA)

Correspondence Address: F. CHAU & ASSOCIATES, LLC, 130 WOODBURY ROAD, WOODBURY, NY, 11797, US

(21) Appl. No.: 11/834,425

(22) Filed: Aug. 6, 2007

(51) Int. Cl. B23K 1/20; B22D 18/00; C03C 15/00

(52) U.S. Cl. 228/249; 164/119; 216/39

(57) ABSTRACT

A method for forming a solder mold for transferring solder to a wafer includes etching a plurality of solder cavities into a substrate. A plurality of ventilation channels are etched on the substrate connecting the plurality of solder cavities.

### BACKGROUND OF THE INVENTION

1. Technical Field

The present disclosure relates to C4 solder molds and, more specifically, to C4 solder molds with venting channels.

2. Discussion of the Related Art

Integrated circuits (ICs) are miniaturized electronic circuits that are incorporated into a small semiconductor chips or die. ICs are generally packaged and mounted to a wiring substrate made from an organic or ceramic material and including multiple layers of wiring. Electrical connections are made between the IC and the first level package substrate, for example, by a process of wire-bonding where small wires are formed to connect the electrical leads of the IC to corresponding leads on the wiring substrate.

Several disadvantages are associated with wire bonding, for example, electrical leads of the IC must be limited to the outer edges of the IC so that the bonding wires do not make contact with each other. One alternative to wire-bonding is flip-chip solder bump interconnection, which as an area array provides an increase number of electrical connections.

In flip-chip interconnection, electrical contacts are provided over the entire top surface of the IC and a pattern of solder bumps is provided over the electrical contacts. When mounting, the IC is flipped so that the solder bumps on the top surface of the IC meet with the electrical contacts of the wiring substrate. A controlled collapse chip connection (C4) process is then performed to reflow the solder and establish a lasting electrical connection between the IC and the substrate. Accordingly, flip-chip interconnection is commonly known as C4.

Much attention has been paid to the manner in which solder bumps are applied to the top surface of the wafer, prior to dicing out the individual chips. According to one method for applying C4 solder bumps, both solder and ball-limiting metallurgy (BLM) are evaporated through holes in a mask to form the desired pattern of solder bumps on the surface of the IC. According to another method for applying solder bumps, solder bumps may be electroplated in areas defined by a photolithographic process. According to another method, solder bumps may be applied to the wafer by a process called screen printing or screening.

Each of the above methods have their respective advantages and disadvantages, however, an alternative approach called injection-molded solder (IMS) is particularly interesting.

In IMS, a pattern of cavities are created on the surface of a mold substrate to form a solder mold. A quantity of molten solder is then injected into each cavity of the solder mold. After solder has been applied to each cavity, the solder mold is then aligned and joined with a wafer so the pattern of solder in the mold corresponds to the electrical contacts of the chips on the wafer. The joined assembly is then heated to reflow the solder bumps and join them to the individual die.

U.S. Pat. Nos. 5,244,143; 6,105,852; 6,390,439; 6,056,191; and 6,832,747, which are hereby incorporated by reference, relate to IMS methods for applying molten solder to a solder mold.

FIG. 1 is a schematic diagram showing an apparatus for performing IMS. The solder mold includes a mold substrate 13 and a plurality of cavities 14 formed thereon. Solder may be injected into each cavity 14 using an IMS head 11 that uses positive pressure to inject a desired quantity of solder 15 from a solder reservoir 12 into the cavities 14. The positive pressure may be supplied to the IMS head 11 by the introduction of a pressurized gas such as nitrogen through a pressure inlet 17. The IMS head 11 may be wide enough to cover the entire width of the wafer and solder may be injected evenly through a long slot across the width of the solder mold. The IMS head 11 may then scan the length of the wafer, for example, by moving the solder mold substrate 13 while the IMS head 11 remains stationary. In such cases, the solder mold is moved opposite to the scan direction. The IMS head 11 may include a solder seal 16 that prevents the solder from leaking beyond the area enclosed by the seal. The seal may be an o-ring or other form of flexible gasket. The seal 16 also pushes excess solder along as the wafer is scanned so that solder does not remain on the surface of the solder mold between the cavities 14.

While solder injection may take place in a vacuum, it is simpler and easier to perform injection in an air environment. Accordingly, as solder is injected into each cavity, displaced air may be allowed to escape through the seal, otherwise complete filling of the cavity may be impeded. The seal may therefore be tight enough to prevent the leakage of molten solder but not so tight as to prevent the escape of air displaced by the injected solder.

Alternatively, the IMS head may provide for the removal of displaced air. In U.S. Pat. No. 6,231,333, which is hereby incorporated by reference, the IMS head includes a vacuum slot which is used to evacuate the cavities prior to solder injection.

### SUMMARY

A method for forming a solder mold for transferring solder to a wafer includes etching a plurality of solder cavities into a substrate. A plurality of ventilation channels are etched on the substrate connecting the plurality of solder cavities.

A method for applying solder to a wafer includes injecting solder into a plurality of solder cavities of a solder mold. The solder mold has a plurality of ventilation channels formed between the plurality of solder cavities. The solder is injected by scanning an injection-molded solder (IMS) injection head in a scan direction across the solder mold. The solder mold including injected solder is aligned to the wafer. The solder injected into the solder mold cavities is transferred to the wafer.

A method for applying solder to a solder mold includes providing a solder reservoir of an injection-molded solder (IMS) injection head with molten solder. Inert gas pressure is provided to the solder reservoir. Molten solder is injected from the solder reservoir into a plurality of solder cavities of the solder mold by moving the solder mold under the IMS injection head in a direction opposite to a scan direction as solder is ejected from the IMS injection head. Air displaced from the solder cavities by the molten solder is allowed to escape into the environment through a plurality of ventilation channels connecting the solder cavities.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a schematic diagram showing an apparatus for performing IMS;

FIG. 2 is a flow chart illustrating a method for performing an IMS process;

FIG. 3 FIGS. 3A and 3B are diagrams illustrating a pattern for ventilation channels according to an exemplary embodiment of the present invention;

FIG. 4 is a diagram illustrating a pattern for ventilation channels according to an exemplary embodiment of the present invention;

FIG. 5 is a diagram illustrating a pattern for ventilation channels according to an exemplary embodiment of the present invention; and

FIG. 6 is a plot of the pressure due to surface tension as a function of size for a channel according to an exemplary embodiment of the present invention.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Injection-molded solder (IMS) processes may be referred to as C4 New Process (C4NP). Exemplary embodiments of the present invention provide for a solder mold including a venting structure for venting air displaced by molten solder during a C4NP.

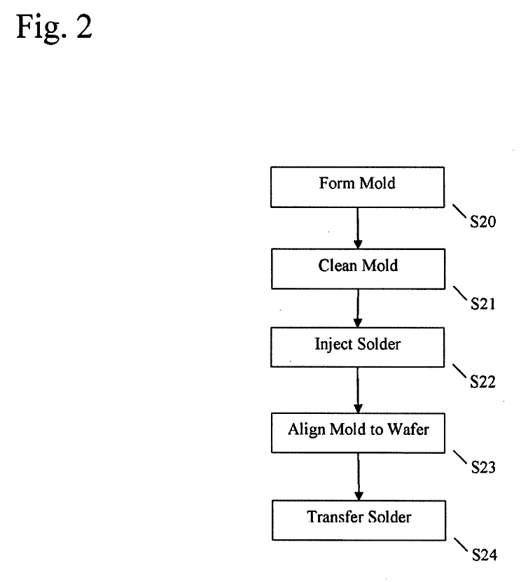

FIG. 2 is a flow chart illustrating a method for performing an IMS processes. First, a mold may first be formed (Step S20). The mold may be formed by providing one or more cavities within a mold substrate. The mold substrate may be made of any rigid material; however, materials with a coefficient of thermal expansion (CTE) that approximately match the CTE of the wafer may be particularly appropriate. For example, where the wafer is formed from silicon, a borosilicate glass mold substrate may be used.

After the mold substrate is formed, the mold may be thoroughly cleaned (Step S21). The cleaned substrate may then undergo solder injection to fill the cavities with molten solder (Step S22). The transparency of the glass substrate may allow for the optical inspection of the mold to ensure that the cavities were properly filled with solder.

The mold may then be aligned to a wafer (Step S23). Alignment of the mold to the wafer may include lining up each solder-filled cavity of the mold with each corresponding electrical contact of the individual die. The transparency of the glass substrate may simplify the process of alignment. Where the mold is made of a material having a similar CTE to the wafer, alignment may be performed at a low temperature because as the mold and wafer are heated, registration will not be lost. The wafer and the mold may then be held in contact or close proximity as they are heated up to the point where the solder reflows and transfers to the wafer (Step S24). The transferred solder becomes solder bumps on the wafer.

The chips may latter be mounted to a wiring substrate such as a first level package by aligning the solder bumps of the die to the electrical contacts of the substrate and applying heat to reflow the solder bumps. A lasting electrical connection may therefore be established between the electrical contacts of the die and the package substrate. The packaged chip can then be electrically interconnected with a printed circuit board by a socket or attached using a solder ball grid array (BGA) with a lower solder reflow temperature.

As discussed above, in performing solder injection, care may be taken to ensure that air displaced from the solder mold cavities is allowed to escape and is not trapped within the mold cavities, resulting in incomplete filling. Exemplary embodiments of the present invention provide for a solder mold that includes a set of ventilation channels for allowing air displaced from the solder mold cavities to dissipate. The ventilation channels may interconnect one or more of the cavities such that air displaced from a cavity may travel through the channels and may dissipate into the environment at a location beyond the IMS head solder seal 16. Accordingly, the ventilation channels may interconnect the cavities along the same axis as the scan direction. Moreover, the ventilation channels may be sized such that they are large enough to permit displaced air flow and yet may be small enough to substantially prevent the molten solder from traveling through the channels and past the solder seal.

Depending on the size of the ventilation channels used, it may be possible for some amount of solder to collect in the ventilation channels as the solder slot passes over them. However, some amount of solder within the ventilation channels need not present a problem. During reflow prior to mold to wafer transfer, solder present in the ventilation channels may be pulled into the solder cavities as the solder begins to melt due to surface tension. Solder that is not pulled into the solder cavities may still not present a problem as it is likely to be below the plane defined by the top surface of the solder bumps and no pad would be present on the wafer for the solder to attach to.

### Channel Patterning

Exemplary embodiments of the present invention seek to provide a pattern of ventilation channels that interconnect the solder mold cavities and allow for the dissipation of air displaced by injected solder. As the IMS head travels in a scan direction relative to the solder mold, and the IMS head may be wide enough to cover the entire width of the wafer, the ventilation channels may interconnect the cavities along the axis of the scan direction so that displaced air may travel through the channels, under the solder seal, and dissipate into the environment at a location not covered by the IMS head and/or not within the IMS head solder seal.

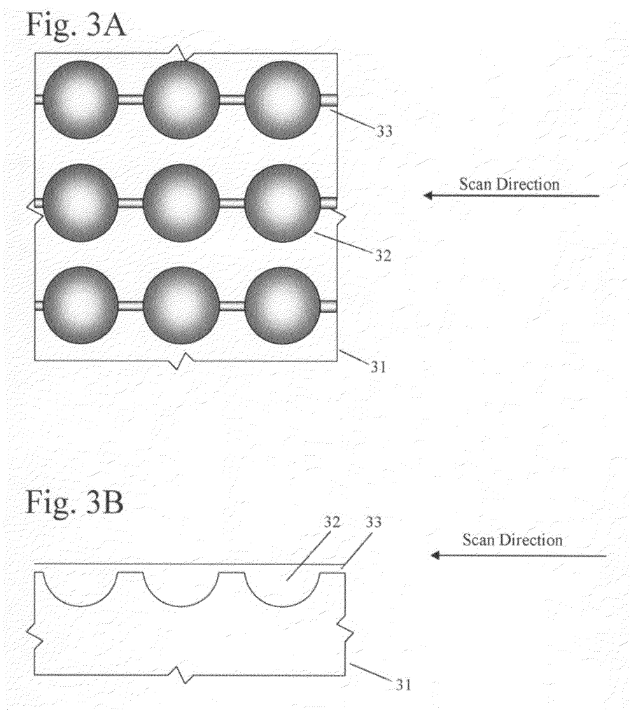

FIGS. 3A and 3B are diagrams illustrating a pattern for ventilation channels according to an exemplary embodiment of the present invention. FIG. 3A is a diagram in plan view and FIG. 3B is a diagram in side view. The solder mold may include a substrate 31 and a set of cavities 32 formed therein. Ventilation channels 33 may connect the cavities 32 in at least one direction. As shown, the ventilation channels 33 may connect the cavities 32 in the scan direction. The ventilation channels 33 may run parallel to each other and parallel to the scan direction, as shown, however, other configurations are possible.

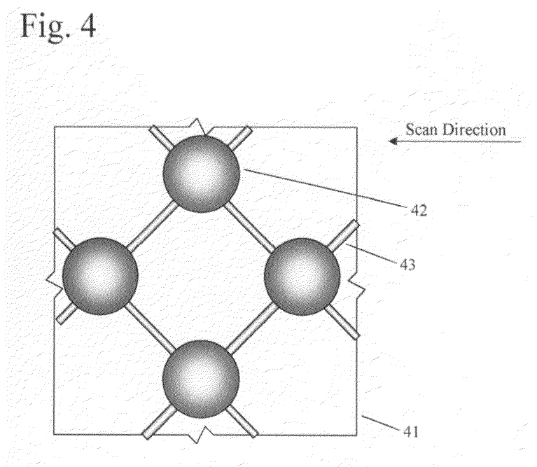

For example, FIG. 4 is a diagram illustrating a pattern for ventilation channels according to an exemplary embodiment of the present invention. Here, the solder mold includes a substrate 41 and a set of cavities 42 formed thereon. Ventilation channels 43 may connect the cavities 42. There may be multiple sets of channels 43 connecting the cavities 42, and as shown, each cavity (with the exception of the outermost cavities) may be connected to a set of four proximate cavities by the ventilation channels. This configuration differs from the exemplary embodiment described above and shown in FIGS. 3A and 3B where each cavity may be connected to a set of two proximate cavities by the ventilation channels. The use of additional channels may reduce the flow resistance of displaced air during ventilation and may provide for redundancy. As seen in FIG. 4, the ventilation channels may be angled 45° from the scan direction, with some of the channels running perpendicular to other of the channels.

In the exemplary embodiment illustrated in FIG. 4, the cavities are said to be connected in the scan direction because a component of the vector representing the orientation of the cavities extends in the scan direction, even if there is coincidentally a component of the vector that extends in an orthogonal direction. Thus if the scan direction is considered an x-direction, the channels may either run entirely in the x-direction and/or the channels may run in a direction having a component in the x-direction and a component in the y-direction.

Accordingly, the ventilation channels may connect the plurality of solder cavities in the scan direction or in a direction that is at an acute angle to the scan direction. There may also be ventilation channels conforming to multiple directions.

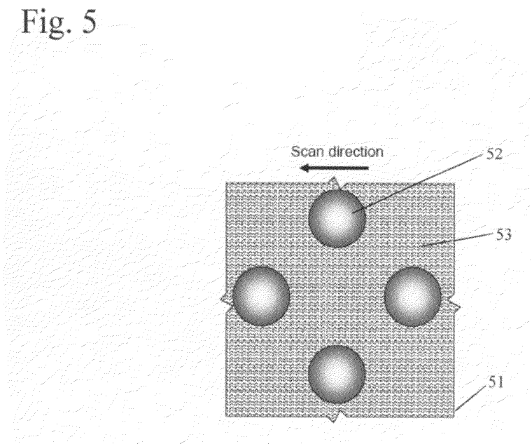

FIG. 5 is a diagram illustrating a pattern for ventilation channels connecting a plurality of solder cavities 52 according to an exemplary embodiment of the present invention. Here, instead of, or in addition to the defined ventilation channels described above, the top-surface 53 of the solder mold substrate 51 may be roughened or corrugated, in a linear manner with at least a directional component in the scan direction and/or by a more random approach. The unevenness of the top surface 53 may therefore prevent the IMS head seal from making an air-tight connection to the solder mold and allow displaced air to ventilate.

### Channel Sizing

As discussed above, the channels may be sized such that air may be allowed to ventilate through the channels and yet the size of the channels substantially prevents the molten solder from flowing through the channels under the solder seal. The viscosity and surface tension of the molten solder may serve to prevent the leakage of the molten solder through the channels under the solder seal as long as the channels are sufficiently small.

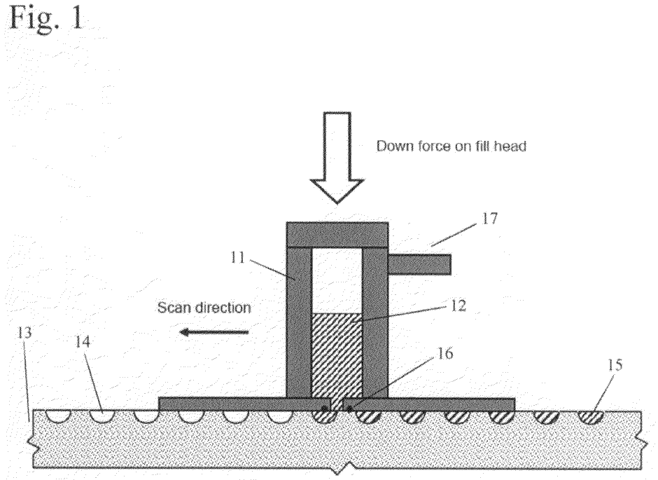

Downward pressure may be placed on the IMS head to increase the sealing force between the IMS head and the solder mold, FIG. 1. Additionally, as discussed above, the solder reservoir in the IMS head may be under positive pressure, for example, by introducing pressurized nitrogen into the solder reservoir. The downwards pressure used, the degree of positive pressure applied and the flexibility of the solder seal and the viscosity of the particular solder mixture may all be factored into determining an appropriate size for the ventilation channels.

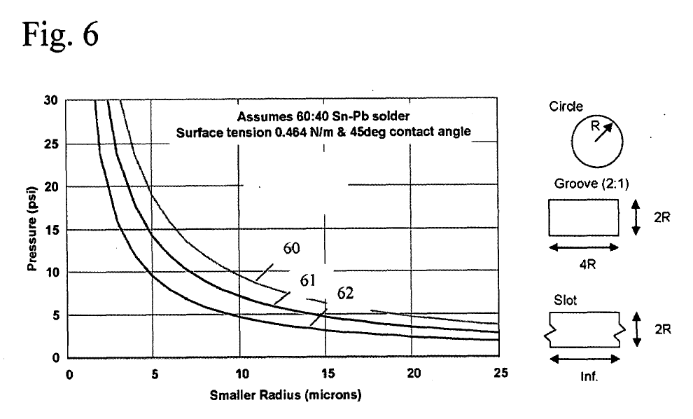

FIG. 6 is a plot of the pressure due to surface tension as a function of size for a channel having a circular opening of radius R (60), a rectangular opening which is 4R by 2R in cross section (61), and a slot which is relatively wide and 2R tall in cross section (62). These plots are based on the following equation:

ΔP=(σ×2×cos Θ)/K (1)

Where ΔP is the pressure differential at the liquid-gas interface from surface tension, σ is the surface tension, assumed to be 0.464 N/m, Θ is the contact angle, assumed to be 45°, and K is the radius for a circular opening and for a rectangular opening where:

2/K=1/R₁+1/R₂ (2)

Here, 2R₁ is the width and 2R₂ is the height of the rectangular opening or slot. The contact angle determines the direction of the force applied. If the solder “wets” (Θ>90°) the material, it is pulled into the channel. If the solder “dewets” (Θ<90°), it is prevented from flowing into the channel unless it can overcome the pressure attributable to the surface tension. Note that solder does not wet glass or polymers such as are used in the solder seal. In experiments with vacuum IMS, as are described in U.S. Pat. No. 6,231,333, hereby incorporated by reference, with a pressure difference of 16 psi, when the linking means was a recess or slot of about 2.5 microns by 4 centimeters, no solder leaked, the performance of a 5 micron tall slot was marginal, and a slot greater than 5 microns tall leaked solder past the solder seal. From the plot of FIG. 6, with a 5 micron tall slot (R=2.5 microns), it appears as though a pressure difference of about 19 psi would be required to cause solder leakage. Where no vacuum is used, the pressure difference between the solder and the region beyond the solder seal in the fill head is lower. It is also seen from FIG. 6 that grooves with a 2:1 width to depth ratio resist solder flow better than wide slots having the same depth. Grooves with a width approximately equal to twice the depth were considered as this approximates the results of grooves that would be formed by an isotropic etching of glass such as the process used to form the cavities on the glass mold substrate.

As mentioned above, in FIG. 6, it is assumed that the solder is a 60:40 Sn—Pb mixture having a surface tension of 0.464 N/m and a 45° contact angle is used. For these assumptions, if the pressure difference across the sliding solder seal is 7 psi, the depth, of a channel that is twice as wide as it is deep, should be less than about 20 microns to prevent solder leakage under the seal. If the differential pressure is reduced to 5 psi, the depth should be less than about 30 microns to prevent solder leakage. The differential pressure across the sliding seal includes contributions both from the nitrogen pressure, above the ambient pressure, and the height of liquid solder in the fill head.

For example, the ventilation channels may have a depth within the range of approximately 1 to 50 microns, more preferably less than about 30 microns, and a width of approximately 1 to 100 microns, more preferably less than about 60 microns. As can be seen from FIG. 6, ventilation channels having a depth of 10 microns and a width of about 20 microns may have a resistance to solder flow corresponding to approximately 14 psi.

### Channel Formation

Channels, such as those described above and illustrated with reference to FIGS. 3A, 3B and 4, may be formed by an etching process. The etching process may be the same as or similar to a process used to form the cavities.

Examples of approaches to forming solder molds by etching cavities into glass substrates may be found in P. A. Gruber et al. “Low-Cost Wafer Bumping” pages 621-639 IBM J. Res. & Dev. Vol. 49, No. 4/5 July/September 2005, and U.S. Pat. No. 6,105,852, both of which are hereby incorporated by reference. As shown in these examples, the cavities may be formed in the glass substrate using dilute hydrofluoric acid (HF) or another isotropic etchant. Photoresist and etching may be used to pattern layers which are not etched by the HF, such as copper over chromium, and these layers may be used as a mask during glass etching, after which they may be removed.

The same or a similar process may be employed for the formation of the channels. With current photolithography equipment, for example, the equipment used for producing the cavities, channels with features as small as 2 microns or less in width may be readily achieved. The depth of the glass etched can be adjusted by the etch time and the concentration of the etchant. Accordingly, etch depths may be 5 to 10 microns or less. For example, if the openings in the etchant resistant layer used during glass etching is smaller than the etch depth, the channel formed may be about twice as wide as it is deep due to the isotropic nature of the etching. The corners of the channels may be rounded, for example, with a radius approximately equal to the etch depth, and with a flat bottom region that may be approximately equal to the opening in the etchant resistant layer. With increased etching, the width and depth may increase and the cross section may approach that of a semicircle.

The ventilation channels may be formed at the same time as the cavities and in so doing, the use of extra processing steps may be avoided. Alternatively, the ventilation channels may be formed independently of the cavities using either the same or different processing steps.

Alternatively, the ventilation channels may be formed by direct laser etching techniques or by other known etching techniques. For example, the ventilation channels may be formed by laser ablation, for example, by scanning a laser beam across the mold surface. For example, a 266 nm femtosecond laser may be focused to a 10 micron (1/e) spot diameter. Channels 5 microns wide and 5 microns deep may therefore be created by controlling the power and scan speed.

Exemplary embodiments of the present invention, where the ventilation channels take the form of a roughened or corrugated surface to the solder mold substrate, such as those described above with reference to FIG. 5, may be created, for example, by abrasion. For example, a rough grit may be used, either in a linear manner at least partially in the scan direction or randomly, to create the roughened or corrugated surface. For example, the surface of the mold substrate may be rubbed with a SiC coated abrasive sheet in a linear manner substantially in the scan direction. The abrasive size may be selected to create scratches and roughness of an appropriate size, for example, channels with a radius within the range of 1 to 25 microns, as shown in FIG. 6.

For example, 2,500 grit SiC abrasive sheets may be used to realize a groove depth of approximately 1 to 2 microns and 1,200 grit abrasive sheets may be used to realize a groove depth of approximately 3 to 6 microns.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for forming a solder mold for transferring solder to a wafer, comprising:
etching a plurality of solder cavities into a substrate; and
etching a plurality of ventilation channels on the substrate, the ventilation channels connecting the plurality of solder cavities.

2. The method of claim 1, wherein the steps of etching the plurality of solder cavities and etching the plurality of ventilation channels are performed substantially at the same time.

3. The method of claim 1, wherein the step of etching the plurality of ventilation channels is performed separately from the step of etching the plurality of solder cavities.

4. The method of claim 1, wherein the etching of the ventilation channels is performed in areas defined by a photolithographic process.

5. The method of claim 1, wherein the etching of the ventilation channels is performed by laser abrasion.

6. The method of claim 1, wherein the etching of the ventilation channels is performed by rubbing a top surface of the substrate with an abrasive sheet.

7. The method of claim 1, wherein the abrasive sheet is rubbed in a linear manner substantially in a scan direction.

8. A method for applying solder to a wafer, comprising:
injecting solder into a plurality of solder cavities of a solder mold having a plurality of ventilation channels formed between the plurality of solder cavities by scanning an injection-molded solder (IMS) injection head in a scan direction across the solder mold;
aligning the solder mold including injected solder to the wafer; and
transferring the solder injected into the solder mold cavities to the wafer.

9. The method of claim 8, wherein the IMS injection head includes a seal for substantially preventing the leakage of molten solder from the IMS injection head to beyond the solder seal but allows for the release of displaced air through the ventilation channels.

10. The method of claim 8, wherein the solder mold substrate comprises glass.

11. The method of claim 8, wherein the solder mold substrate has a coefficient of thermal expansion (CTE) that approximately matches a CTE of the wafer.

12. The method of claim 8, wherein the step of transferring the solder injected into the solder mold cavities to the wafer comprises heating the solder in the solder mold to at least a temperature where the solder reflows.

13. The method of claim 8, additionally comprising mounting the wafer to a wiring substrate by aligning the solder transferred to the wafer to electrical contacts of the wiring substrate and applying heat to reflow the solder.

14. A method for applying solder to a solder mold, comprising:
providing a solder reservoir of an injection-molded solder (IMS) injection head with molten solder;
providing gas pressure to the solder reservoir;
injecting molten solder from the solder reservoir into a plurality of solder cavities of the solder mold by moving the solder mold under the IMS injection head in a direction opposite to a scan direction as solder is ejected from the IMS injection head; and
allowing for air displaced from the solder cavities by the molten solder to escape through a plurality of ventilation channels connecting the solder cavities on the substrate.

15. The method of claim 14, wherein the plurality of ventilation channels connect the plurality of solder cavities in the scan direction.

16. The method of claim 14, wherein the plurality of ventilation channels connect the plurality of solder cavities in a direction at an acute angle to the scan direction.

17. The method of claim 14, wherein the plurality of ventilation channels formed between the plurality of solder cavities comprises a roughened or corrugated surface of the substrate.

18. The method of claim 14, wherein the plurality of solder cavities and the plurality of ventilation channels are etched into a substrate of the solder mold in a pattern defined by a photolithographic process.

19. The method of claim 14, wherein the plurality of ventilation channels are provided by laser abrasion.

20. The method of claim 14, wherein the plurality of ventilation channels are provided by rubbing a top surface of a substrate of the solder mold with an abrasive sheet.
